(19) United States
(12) Patent Application Publication
(10) Pub. No.: US 2024/0022801 A1
(43) Pub. Date: Jan. 18, 2024

(54) LENS MODULE

(71) Applicant: NEWMAX TECHNOLOGY CO., LTD., Taichung City (TW)

(72) Inventors: Kun-Ta YANG, Taichung City (TW); Chi-Lung WEI, Taichung City (TW); Pei-Ling CHEN, Taichung City (TW)

(21) Appl. No.: 17/951,240

(22) Filed: Sep. 23, 2022

(30) Foreign Application Priority Data
Jul. 18, 2022 (TW) 111126829

(51) Int. Cl. H04N 5/225

(52) U.S. Cl. CPC H04N 5/22521; H04N 5/2254

(57) ABSTRACT

A lens module includes: a barrel having a stepped portion including first and second stepped surfaces, wherein the first stepped surface is closer to a central axis than the second stepped surface; a front cover including a first portion and a second portion, wherein the first portion corresponds to the first stepped surface, the second portion corresponds to the second stepped surface, and the barrel is disposed in the front cover; an optical lens assembly disposed in the barrel and including a first lens, wherein an annular accommodating space is formed by an outer annular surface of the first lens, the first stepped surface of the barrel, and the first portion of the front cover; and an adhesive disposed in the annular accommodating space and in contact with the outer annular surface of the first lens, the first stepped surface, and the first portion.

### CROSS-REFERENCE TO RELATED APPLICATION

This application claims the benefit of Taiwan Patent Application No. 111126829, filed on Jul. 18, 2022, which is hereby incorporated by reference for all purposes as if fully set forth herein.

### BACKGROUND

Technical Field

The present disclosure relates to a lens module, and in particular, to a lens module whose front cover has a design configured for adhesive dispensing onto the front cover.

### Related Art

Poor waterproofness of a lens module for vehicles may cause bad visibility and hard to monitor the peripheral condition of the vehicle. This may result in a serious traffic accident and even life safety. The lens module for vehicles generally includes a front cover, a barrel, and a plurality of lenses disposed in the barrel. A waterproof structure is disposed between a lens on an outermost end of the lens module for vehicles and the barrel to prevent external water from entering the barrel. However, the waterproof structure is generally a sealing ring having normal waterproof performance. Once the sealing ring is aged, water seepage is easily caused. In this way, the waterproof effect cannot be achieved.

At present, the adhesive is required to be dispensed twice during assembly of the front cover of the lens module for vehicles, and especially the adhesive prone to overflow during adhesive dispensing on an outer side of the front cover affects the appearance of the lens module for vehicles. Therefore, it is necessary to spend a long time to solve the problem of the appearance caused by the adhesive dispensing. In addition, if an amount of adhesive glue is reduced for shortening the dispensing process time and reducing process costs, the adhesive strength of the front cover is insufficient, and the periphery cannot be sealed with adhesive glue. In this way, the waterproof effect cannot be achieved.

Therefore, it is necessary to provide a lens module, so as to resolve the foregoing problems.

### SUMMARY

The present disclosure is intended to provide a lens module. A front cover of the lens module has a design configured for adhesive dispensing onto the front cover.

To achieve the above objective, the present disclosure provides a lens module, defining a central axis, an object side, and an image side opposite to the object side, and the lens module comprising: a barrel comprising an object-side surface, a stepped portion, and an outer annular surface, wherein the stepped portion is disposed on the object-side surface and comprises a first stepped surface and a second stepped surface, the first stepped surface is closer to the central axis than the second stepped surface, and the outer annular surface of the barrel is close to the object side; a front cover comprising a first portion and a second portion, wherein the first portion corresponds to the first stepped surface of the barrel, the second portion corresponds to the second stepped surface of the barrel, and the barrel is disposed in the front cover; an optical lens assembly disposed in the barrel and comprising a first lens, wherein the first lens is a lens of the optical lens assembly closest to the object side, the first lens comprises an outer annular surface, and an annular accommodating space is formed by the outer annular surface of the first lens, the first stepped surface of the barrel, and the first portion of the front cover; and an adhesive disposed in the annular accommodating space and in contact with the outer annular surface of the first lens, the first stepped surface of the barrel, and the first portion of the front cover.

According to the lens module of the present disclosure, when the front cover is assembled, adhesive dispensing is required only once, so that the first lens and the front cover can be fixed to the barrel, the usage amount of adhesive glue and the assembling time can be reduced, thereby reducing manufacturing costs. Moreover, the front cover has a design configured for adhesive dispensing onto the front cover. In this way, the gluing strength of the front cover can be strengthened, and the usage amount of adhesive glue used and the assembling time can also be reduced, thereby reducing the manufacturing costs.

### BRIEF DESCRIPTION OF THE DRAWINGS

FIG. 1 is a partially schematic cross-sectional view of a lens module according to an embodiment of the present disclosure.

FIG. 2 is a first schematic cross-sectional view of part A of the lens module of FIG. 1, showing that there is an adhesive, and an inner annular surface of a front cover is in contact with an outer annular surface of a barrel.

FIG. 3 is a second schematic cross-sectional view of part A of the lens module of FIG. 1, showing that there is no adhesive.

FIG. 4 is a schematic cross-sectional view of part B of the lens module of FIG. 1, showing that an inner annular surface of a front cover is not in contact with an outer annular surface of a barrel.

FIG. 5 is an enlarged schematic cross-sectional view of part C of the lens module of FIG. 1, showing that there is no adhesive.

FIG. 6 is an enlarged schematic cross-sectional view of part D of the lens module of FIG. 1, showing that there is no adhesive.

FIG. 7 is an enlarged schematic cross-sectional view of part E of the lens module of FIG. 1, showing that there is no adhesive.

FIG. 8 is a schematic cross-sectional view of an assembling method of a lens module according to an embodiment of the present disclosure.

### DETAILED DESCRIPTION

To make the foregoing objective, features, and characteristics of the present disclosure clearer and more comprehensive, related embodiments of the present disclosure are described in detail below with reference to the accompanying drawings.

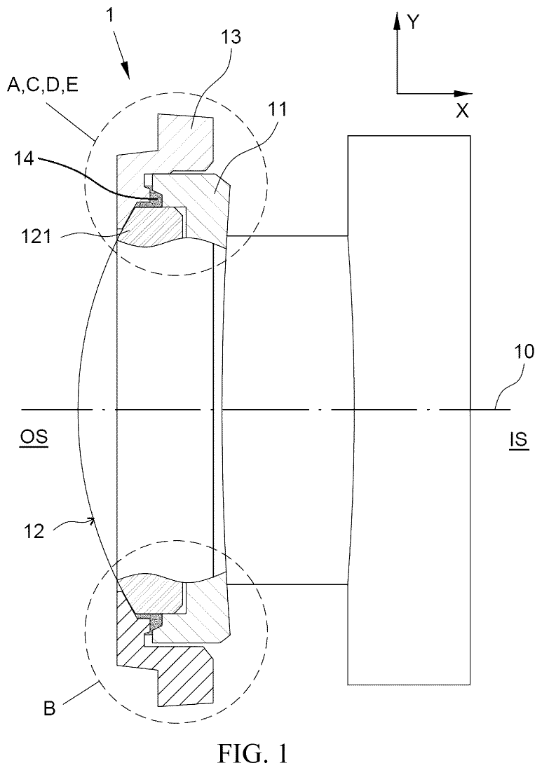

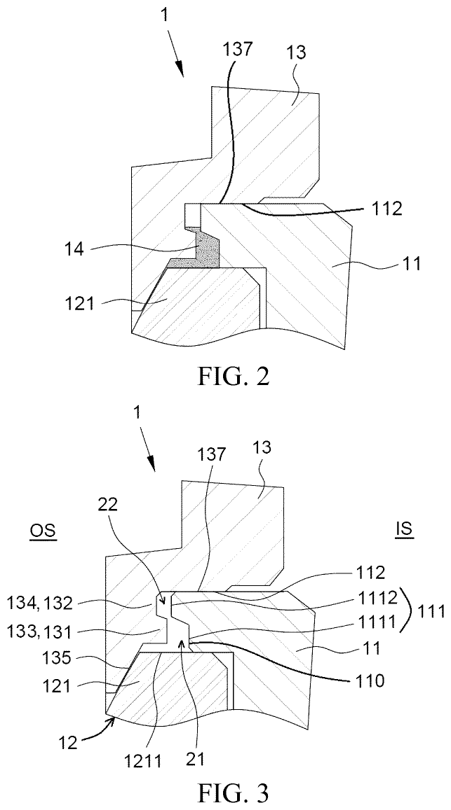

FIG. 1 is a partially schematic cross-sectional view of a lens module according to an embodiment of the present disclosure. FIG. 2 and FIG. 3 are first and second schematic cross-sectional views of part A of the lens module of FIG. 1. Referring to FIG. 1 to FIG. 3, the lens module 1 defines a central axis 10, an object side OS, and an image side IS opposite to the object side OS. The lens module 1 further defines an axial direction X and a radial direction Y. The axial direction X is perpendicular to the radial direction Y, and the axial direction X is parallel to the central axis 10. The lens module 1 includes a barrel 11, a front cover 13, an optical lens assembly 12, and an adhesive 14 (that is, adhesive glue). The barrel 11 includes an object-side surface 110, a stepped portion 111, and an outer annular surface 112. The stepped portion 111 is disposed on the object-side surface 110 and includes a first stepped surface 1111 and a second stepped surface 1112. The first stepped surface 1111 is closer to the central axis 10 than the second stepped surface 1112, and the second stepped surface 1112 of the barrel 11 is closer to the object side OS than the first stepped surface 1111. The outer annular surface 112 of the barrel 11 is an outer annular surface close to the object side OS. The barrel 11 and the front cover 13 may be made of plastic materials.

Referring to FIG. 3 again, the front cover 13 includes a first portion 131 and a second portion 132. The first portion 131 corresponds to the first stepped surface 1111 of the barrel 11, the second portion 132 corresponds to the second stepped surface 1112 of the barrel 11, and the barrel 11 is disposed in the front cover 13. The first portion 131 of the front cover 13 is closer to the image side IS than the second portion 132. The front cover 13 further includes an inner annular surface 137 surrounding the outer annular surface 112 of the barrel 11.

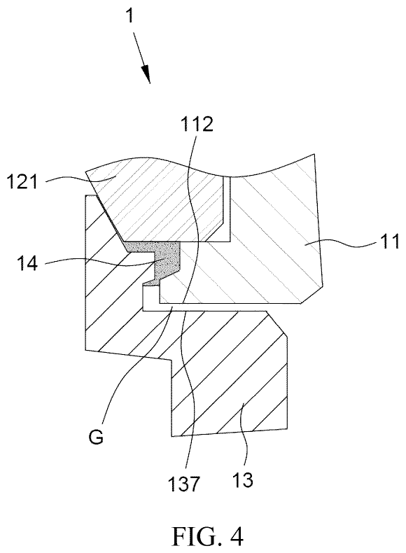

FIG. 2 shows that the inner annular surface 137 of the front cover 13 is in contact with the outer annular surface 112 of the barrel 11. FIG. 4 shows that the inner annular surface 137 of the front cover 13 is not in contact with the outer annular surface 112 of the barrel 11. For example, a gap G can be provided between the inner annular surface 137 and the outer annular surface 112. Therefore, the inner annular surface 137 of the front cover 13 is partially in contact with the outer annular surface 112 of the barrel 11, so as to be used for positioning and exhausting.

Referring to FIG. 3 again, the optical lens assembly 12 is disposed in the barrel 11. The optical lens assembly 12 includes, in order from the object side OS to the image side IS: a plurality of optical lenses, and the optical lenses may be made of a plastic material or a glass material. Other optical elements may also be disposed in the barrel 11. For example, the other optical element may include a spacer ring, an optical filter (for example, an infrared optical filter, an infrared bandpass optical filter, or other optical band filters), a light-shielding element (for example, an aperture stop or a stop configured to correct edge light), or the like. In this embodiment, the optical lens assembly 12 includes a first lens 121. The first lens 121 is a lens closest to the object side OS of the optical lens assembly 12, and includes an outer annular surface 1211. An annular accommodating space 21 is formed by the outer annular surface 1211 of the first lens 121, the first stepped surface 1111 of the barrel 11, and the first portion 131 of the front cover 13.

In detail, the first portion 131 of the front cover 13 is a protruding portion 133, and the annular accommodating space 21 is formed by the protruding portion 133, the outer annular surface 1211 of the first lens 121, and the first stepped surface 1111 of the barrel 11. The second portion 132 of the front cover 13 is a recessed portion 134, and an air space 22 is formed between the recessed portion 134 and the second stepped surface 1112 of the barrel 11. The air space 22 is in communication with the annular accommodating space 21 and is used for adhesive overflow and exhausting.

Referring to FIG. 2 and FIG. 3 again, the adhesive 14 is disposed in the annular accommodating space 21 and is in contact with the outer annular surface 1211 of the first lens 121, the first stepped surface 1111 of the barrel 11, and the first portion 131 of the front cover 13. The protruding portion 133 of the front cover 13 can be regarded as a design configured for adhesive dispensing onto the front cover, so as to strengthen gluing strength of the front cover and reduce a usage amount of adhesive glue, and further reduce manufacturing costs. At least one of the first portion 131 of the front cover 13 and the first stepped surface 1111 of the barrel 11 includes a roughened surface for increasing an adhesion area with the adhesive 14, thereby increasing the adhesive force.

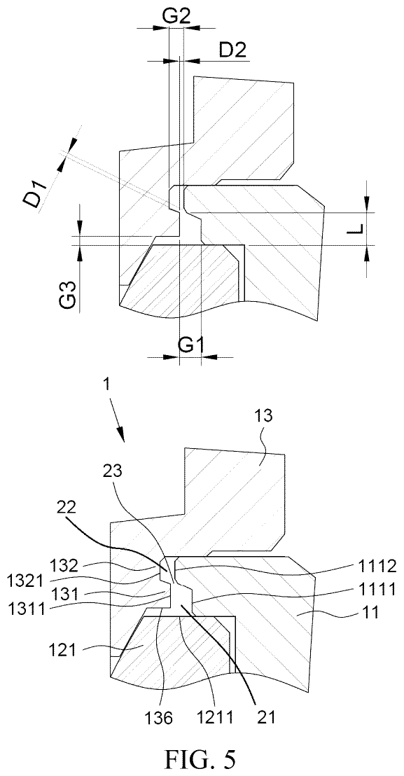

FIG. 5 is an enlarged schematic cross-sectional view of part C of the lens module of FIG. 1. Referring to FIG. 5, in Embodiment 1, the first portion 131 of the front cover 13 has a first image-side surface 1311. A gap between the first image-side surface 1311 and the first stepped surface 1111 of the barrel 11 is G1, where G1=0.160 mm. The second portion 132 of the front cover 13 has a second image-side surface 1321. A gap between the second image-side surface 1321 and the second stepped surface 1112 of the barrel 11 is G2, where G2=0.090 mm. An axial distance between the first image-side surface 1321 of the front cover 13 and the second stepped surface 1112 of the barrel 11 is D2, where D2=0.040 mm. The first portion 131 of the front cover 13 has a radial surface 136 facing the central axis 10, and a gap between the radial surface 136 and the outer annular surface 1211 of the first lens 121 is G3. In this way, the adhesion area with the adhesive 14 can be increased, and the adhesive force can be increased. For example, G3=0.043 mm. A radial length of the first stepped surface 1111 of the barrel 11 is L, where L=0.175 mm. In Embodiment 1, a projection of the first portion 131 of the front cover 13 on the central axis 10 does not overlap a projection of the second stepped surface 1112 on the central axis 10, and the first portion 131 is not closer to the first stepped surface 1111. Therefore, more adhesive glue is required for the annular accommodating space 21 to fix the lens module.

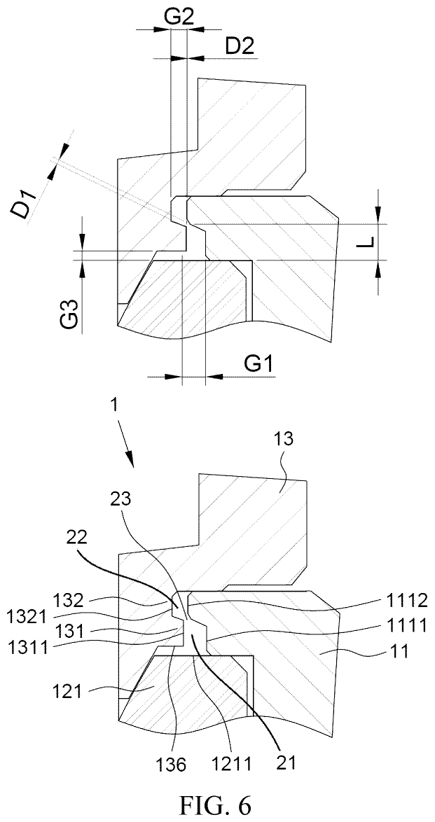

FIG. 6 is an enlarged schematic cross-sectional view of part D of the lens module of FIG. 1. Referring to FIG. 6, in Embodiment 2, the first portion 131 of the front cover 13 has a first image-side surface 1311, and a gap between the first image-side surface 1311 and the first stepped surface 1111 of the barrel 11 is G1, where G1=0.120 mm. The second portion 132 of the front cover 13 has a second image-side surface 1321. A gap between the second image-side surface 1321 and the second stepped surface 1112 of the barrel 11 is G2, where G2=0.090 mm. An axial distance between the first image-side surface 1321 of the front cover 13 and the second stepped surface 1112 of the barrel 11 is D2, where D2=0.000 mm. The first portion 131 of the front cover 13 has a radial surface 136 facing the central axis 10, and a gap between the radial surface 136 and the outer annular surface 1211 of the first lens 121 is G3. In this way, the adhesion area with the adhesive 14 can be increased, and the adhesive force can be increased. For example, G3=0.043 mm. A radial length of the first stepped surface 1111 of the barrel 11 is L, where L=0.175 mm. In Embodiment 2, a projection of the first portion 131 of the front cover 13 on the central axis is exactly aligned with a projection of the second stepped surface 1112 on the central axis 10, and the first portion 131 is close to the first stepped surface 1111. Therefore, a certain amount of adhesive glue is required for the annular accommodating space 21 to fix the lens module.

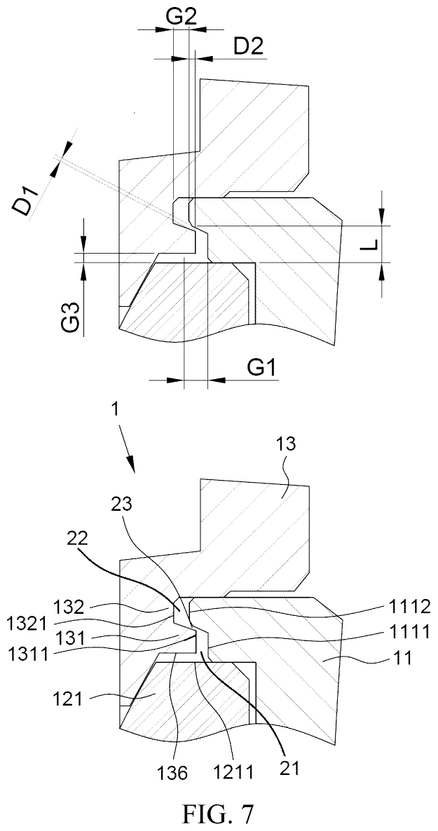

FIG. 7 is an enlarged schematic cross-sectional view of part E of the lens module of FIG. 1. Referring to FIG. 7, in Embodiment 3, the first portion 131 of the front cover 13 has a first image-side surface 1311, and a gap between the first image-side surface 1311 and the first stepped surface 1111 of the barrel 11 is G1, where G1=0.074 mm. The second portion 132 of the front cover 13 has a second image-side surface 1321. A gap between the second image-side surface 1321 and the second stepped surface 1112 of the barrel 11 is G2, where G2=0.090 mm. An axial distance between the first image-side surface 1321 of the front cover 13 and the second stepped surface 1112 of the barrel 11 is D2, where D2=0.046 mm. The first portion 131 of the front cover 13 has a radial surface 136 facing the central axis 10, and a gap between the radial surface 136 and the outer annular surface 1211 of the first lens 121 is G3. In this way, the adhesion area with the adhesive 14 can be increased, and the adhesive force can be increased. For example, G3=0.043 mm. A radial length of the first stepped surface 1111 of the barrel 11 is L, where L=0.175 mm. In Embodiment 3, a projection of the first portion 131 of the front cover 13 on the central axis 10 overlaps a projection of the second stepped surface 1112 on the central axis 10, and the first portion 131 is closest to the first stepped surface 1111. Therefore, less adhesive glue is required for the annular accommodating space 21 to fix the lens module.

A size of the annular accommodating space 21 can be adjusted according to characteristics of the adhesive 14, characteristics of a product application (a mobile phone, a notebook computer, a monitor, vehicle photography, and the like) of the lens module, or a manufacturing process.

A design value of the G1 may be calculated from Embodiments 1-3 of FIG. 5 to FIG. 7: 0.074 mm≤G1≤0.16 mm. Moreover, when the projection of the first portion 131 of the front cover 13 on the central axis 10 does not overlap the projection of the second stepped surface 1112 on the central axis 10, D2 is less than or equal to 0.04 mm. When the projection of the first portion 131 of the front cover 13 on the central axis 10 overlaps the projection of the second stepped surface 1112 on the central axis 10, D2 is less than or equal to 0.046 mm. In addition, a channel 23 is further disposed between the annular accommodating space 21 and the air space 22, a hole diameter of the channel 23 is D1, for example D1=0.028 mm, and the adhesive 14 can be disposed in the channel 23 and the air space 22.

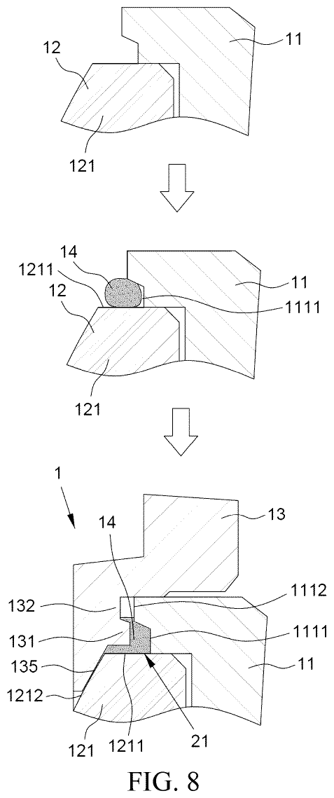

FIG. 8 is a schematic cross-sectional view of an assembling method of a lens module according to an embodiment of the present disclosure. The assembling method of the lens module 1 includes the following steps.

In step A, a barrel 11 is provided, and an optical lens assembly 12 is disposed in the barrel 11. The optical lens assembly 12 includes a first lens 121. The first lens 121 is a lens of the optical lens assembly 12 being closest to an object side.

In step B, an adhesive 14 is annularly dispensed on an outer annular surface 1211 of the first lens 121 and a first stepped surface 1111 of the barrel 11.

In step C, the barrel 11 is disposed in a front cover 13. The front cover 13 includes a first portion 131 and a second portion 132. The first portion 131 corresponds to the first stepped surface 1111 of the barrel 11, and the second portion 132 corresponds to the second stepped surface 1112 of the barrel 11. In this way, an annular accommodating space 21 is formed by the outer annular surface 1211 of the first lens 121, the first stepped surface 1111 of the barrel 11, and the first portion 131 of the front cover 13. The adhesive 14 is disposed in the annular accommodating space 21, and the adhesive 14 is in contact with the outer annular surface 1211 of the first lens 121, the first stepped surface 1111 of the barrel 11, and the first portion 131 of the front cover 13. In addition, the front cover 13 further includes an inclined surface 135. The inclined surface is adjacent to the first portion 131 and is partially in contact with a non-optical surface 1212 of the first lens 121, so that the front cover 13 is positioned on the first lens 121.

According to the lens module of the present disclosure, when the front cover is assembled, adhesive dispensing is required only once, so that the first lens and the front cover can be fixed to the barrel, the usage amount of adhesive glue and the assembling time can be reduced, thereby reducing manufacturing costs. Moreover, the front cover has a design configured for adhesive dispensing onto the front cover. In this way, the gluing strength of the front cover can be strengthened, and the usage amount of adhesive glue used and the assembling time can also be reduced, thereby reducing the manufacturing costs.

In conclusion, the foregoing descriptions only describes preferred implementations or embodiments of technical means adopted in the present disclosure for resolving problems, and are not intended to limit the implementation scope of the present disclosure. That is, any equivalent changes and modifications literally conforming to the scope of the claims of the present disclosure or made according to the scope of the claims of the present disclosure shall fall within the scope of the present disclosure.

What is claimed is:

1. A lens module, defining a central axis, an object side, and an image side opposite to the object side, and the lens module comprising:
a barrel comprising an object-side surface, a stepped portion, and an outer annular surface, wherein the stepped portion is disposed on the object-side surface and comprises a first stepped surface and a second stepped surface, the first stepped surface is closer to the central axis than the second stepped surface, and the outer annular surface of the barrel is close to the object side;
a front cover comprising a first portion and a second portion, wherein the first portion corresponds to the first stepped surface of the barrel, the second portion corresponds to the second stepped surface of the barrel, and the barrel is disposed in the front cover;
an optical lens assembly disposed in the barrel and comprising a first lens, wherein the first lens is a lens of the optical lens assembly closest to the object side, the first lens comprises an outer annular surface, and an annular accommodating space is formed by the outer annular surface of the first lens, the first stepped surface of the barrel, and the first portion of the front cover; and
an adhesive disposed in the annular accommodating space and in contact with the outer annular surface of the first lens, the first stepped surface of the barrel, and the first portion of the front cover.

2. The lens module according to claim 1, wherein the first portion of the front cover is a protruding portion, and the annular accommodating space is formed by the protruding portion, the outer annular surface of the first lens, and the first stepped surface of the barrel.

3. The lens module according to claim 2, wherein the second portion of the front cover is a recessed portion, an air space is formed between the recessed portion and the second stepped surface of the barrel, and the air space is in communication with the annular accommodating space.

4. The lens module according to claim 3, wherein a channel is provided between the annular accommodating space and the air space, and the adhesive is disposed in the channel and the air space.

5. The lens module according to claim 1, wherein the first portion of the front cover is closer to the image side than the second portion, and the second stepped surface of the barrel is closer to the object side than the first stepped surface.

6. The lens module according to claim 5, wherein the first portion of the front cover has a first image-side surface, a gap between the first image-side surface and the first stepped surface of the barrel is G1, and the following condition is satisfied: 0.074 mm≤G1≤0.160 mm.

7. The lens module according to claim 6, wherein an axial distance between the first image-side surface of the front cover and the second stepped surface of the barrel is D2, D2 is less than or equal to 0.04 mm when a projection of the first portion of the front cover on the central axis does not overlap a projection of the second stepped surface on the central axis, and D2 is less than or equal to 0.046 mm when the projection of the first portion of the front cover on the central axis overlaps the projection of the second stepped surface on the central axis.

8. The lens module according to claim 1, wherein the first portion of the front cover has a radial surface facing the central axis, and a gap is provided between the radial surface and the outer annular surface of the first lens.

9. The lens module according to claim 1, wherein the front cover further comprises an inner annular surface surrounding and partially in contact with the outer annular surface of the barrel.

10. The lens module according to claim 1, wherein the front cover further comprises an inclined surface adjacent to the first portion, and partially in contact with a non-optical surface of the first lens.

11. The lens module according to claim 1, wherein at least one of the first portion of the front cover or the first stepped surface of the barrel comprises a roughened surface.
